(19) United States
(12) Patent Application Publication
(10) Pub. No.: US 2010/0236530 A1
(43) Pub. Date: Sep. 23, 2010

(54) Fuel saving and waste gas purifying device for internal combustion engine

(76) Inventor: Jen Chieh Liu, Pingjhen City (TW)

Correspondence Address: Muncy, Geissler, Olds & Lowe, PLLC, 4000 Legato Road, Suite 310, FAIRFAX, VA, 22033, US

(21) Appl. No.: 12/004,484

(22) Filed: Dec. 21, 2007

(30) Foreign Application Priority Data
Dec. 22, 2006 (TW) 095222627

(51) Int. Cl. F02M 27/00

(52) U.S. Cl. 123/538

(57) ABSTRACT

A fuel saving and waste gas purifying device of an internal combustion engine having a communicating tube which includes an input end, an output end and an intake end communicating with one another, the input end and the output end are connected to a fuel input tube of the internal combustion engine, a one-way valve is provided in the intake end of the communicating tube; a negative ion generator is communicated between the communicating tube and the intake end, a power source of a power machine is connected with the negative ion generator for generating a large amount of negative ions in the intake end of the communicating tube; by one-way putting out the air with the negative ions into the communicating tube between the input end and the output end, the negative ions are mixed with the fuel in the communicating tube to form mixed gas in advance; when the mixed gas enters the engine mixes once more with the intake gas of the engine per se, the fuel will mix with the air more completely, this can increase the efficiency of combustion.

### BACKGROUND OF THE INVENTION

1. Field of the Invention

The present invention relates to a fuel saving device, and especially to a fuel saving and waste gas purifying device that suits to a power mechanical internal combustion engine and communicates a negative ion generator with a fuel input tube of the internal combustion engine to get an effect of fuel saving for the internal combustion engine and air purification.

2. Description of the Prior Art

In various environmental pollution sources, waste gases exhausted from power mechanical internal combustion engines including cars, motorcycles etc. are of the largest ratio; in view of this, it is a big subject in the present days to find a way to reduce generation of gases from power mechanical internal combustion engines. While before seeking the effect of inhibiting generation of waste gases, we must know the components of the waste gases in the power mechanical internal combustion engines.

For example: gasoline being the main power source of an internal combustion engine is a kind of hydrocarbon, molecules in the gasoline almost are carbon and hydrogen atoms, these carbon and hydrogen atoms will generate carbon dioxide and water when they are mixed with air and combusted, however, due to uncompleted combustion and exhausting of a little of the mixed gas, HC (hydrocarbon) and CO (carbon oxide) are generated. And more, air entering the internal combustion engine contains 80% nitrogen (N₂), it passes through a combustion chamber having high temperature, the originally stable nitrogen will combined with oxygen (O₂) in the air to generate NO and NO₂, this not only can make environmental pollution, but also can make hurt of human bodies.

Under an ideal condition, the volume of the air entering the internal combustion engine equals to the gas exhausting amount of a cylinder; however, parts such as an air filter, a throttle or an air channel can form resistance against air intake, thereby temperature of the gas absorbed into the cylinder is higher, but density is lower; therefore in a practical state, it is impossible that under the atmosphere, air entering the cylinder can be in an amount equal to the gas exhausting amount; in view of this, the maximum volume efficiency during general natural gas taking in an engine when its accelerator is totally opened is about 75% to 80%; and the higher the rate of the engine is or the smaller the degree of opening of the accelerator is, the lower the volume efficiency of the engine will be. Therefore, when the volume of air entering the cylinder is smaller than the gas exhausting amount, the mixed gas is unable to be completely combusted, and HC and CO are generated, this can make air pollution.

To get rid of the above defects to make the mixed gas have the effect of completed combustion, manufacturers in the art has developed many techniques, including recovering waste gas for combustion once more, using magnetic force to decompose the large molecular structures of gasoline into small molecular structures, and providing various ways of saving fuels but enhancing combustion, and thus to contribute to a reduction of air pollution.

However, the above stated ways are unable to increase the oxygen dissolving amount of gasoline to increase the effects of combustion and output horsepower. And even the mixed gas is nearly completely combusted, a phenomenon of positive ion static electricity absorption resulted from the movement of the piston in the internal combustion engine is unable to be solved; thereby a problem of resistance against piston running is increased. The ways also are unable to avoid the phenomenon of floating of exhausted waste gases in the air. Therefore, there still has room space for advancing in the efficiency of power increasing, fuel saving and in the effect of reducing air pollution.

In view of this, for the purpose of eliminating the above stated defects, and to allow the device of fuel saving and waste gas purifying to make completed combustion of fuel to enhance output horsepower, and to reduce the resistance against piston running in the internal combustion engine, to stabilize the function of waste gas exhausting and air purification, the inventor thus provides the present invention based on his professional experience of years and non-stop studying and development.

### SUMMARY OF THE INVENTION

The primary object of the present invention is to provide a fuel saving and waste gas purifying device, wherein a negative ion generator is used to render the air in the air intake end of a communicating tube to have a large amount of negative ions, the air then is put in a structure of an input tube of an internal combustion engine; this can increase the oxygen dissolving amount of the fuel in the fuel input tube to make completed combustion of the mixed gas, and to increase the effects of combustion and output horsepower.

The secondary object of the present invention is to provide a fuel saving and waste gas purifying device, wherein a negative ion generator is used to generate a large amount of negative ions to be put in the structure of a cylinder of an internal combustion engine; this can neutralize the positive ions generated by friction between the piston and the cylinder to eliminate the phenomenon of positive ion static electricity absorption and to reduce the resistance against piston running and thereby to save fuel.

Another object of the present invention is to provide a fuel saving and waste gas purifying device, wherein a negative ion generator is used to generate a large amount of negative ions which are exhausted out of the structure of a power machine in order to neutralize the polluted material with positive electric charges in the air, such as waste gas of a car, dust, virus, germs etc., so that the material precipitates after it is in a state of no electric charge, and an object of air purifying can be achieved.

A further object of the present invention is to provide a fuel saving and waste gas purifying device, wherein there is a structure makes mutual connecting among a communicating tube having a function of generating negative pressure, a negative pressure generator and a fuel input tube of an internal combustion engine, so that when in flowing of the fuel in the fuel input tube, the device automatically absorbs air containing a large amount of negative ions for mixing with the fuel in the fuel input tube in advance.

Another object of the present invention is to provide a fuel saving and waste gas purifying device in which a function that air entering the intake end of the communicating tube is cooled by low temperature fuel in the fuel input tube is provided, thereby air temperature is lowered, and air volume is reduced, density is increased, these can increase the volume efficiency of the engine during gas taking in, so that an effect of completed combustion of the mixed gas can be obtained.

For achieving the above stated objects, the fuel saving and waste gas purifying device of the internal combustion engine of the present invention comprises a communicating tube and a negative ion delivery device, the communicating tube includes an input end, an output end and an intake end communicated with one another, the input end and the output end are connected respectively to a fuel input tube of the internal combustion engine in order that fuel in the fuel input tube enters the input end, and is put out of the output end, a one-way valve is provided in the intake end. The negative ion delivery device includes a negative ion generator which is communicated with the intake end of the communicating tube, a power source is connected with the negative ion generator in order to generate a large amount of negative ions; by one-way putting out of the intake end of the communicating tube into the communicating tube, the negative ions are mixed with the fuel in the communicating tube.

When in practicing, the communicating tube includes a reduced neck portion which is located between the input end and the output end, and the reduced neck portion is communicated with the intake end.

And when in practicing, the communicating tube can also include a mixing chamber which is provided at one side of the reduced neck portion, and the intake end is communicated with the mixing chamber.

The present invention will be apparent after reading the detailed description of the preferred embodiment thereof in reference to the accompanying drawings.

### BRIEF DESCRIPTION OF THE DRAWINGS

FIG. 1 is a sectional view showing a first embodiment of the present invention after assembling;

FIG. 2 is a sectional view showing the first embodiment of the present invention after assembling in another mode;

FIG. 3 is a sectional view showing use of the first embodiment of the present invention;

FIG. 4 is a sectional view showing a second embodiment of the present invention after assembling;

FIG. 5 is a sectional view showing a third embodiment of the present invention after assembling.

### DETAILED DESCRIPTION OF THE PREFERRED EMBODIMENT

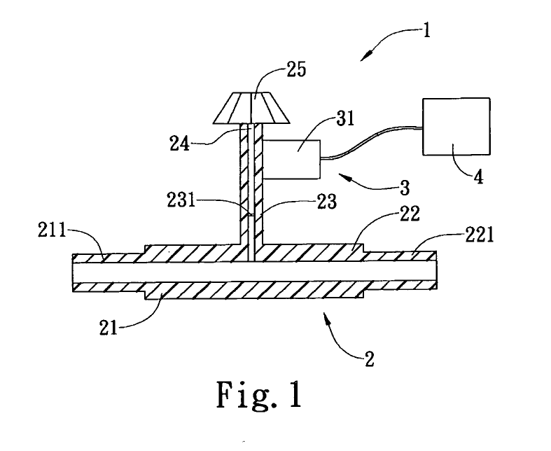

Referring firstly to FIG. 1 showing a first embodiment of a fuel saving and waste gas purifying device 1 of the internal combustion engine of the present invention, the device 1 comprises a communicating tube 2 and a negative ion delivery device 3.

The communicating tube 2 is a “T” typed tube, it includes an input end 21, an output end 22 and an intake end 23 communicated with one another, the input end 21 and the output end 22 are provided each with a reduced connecting neck portion 211, 221; one end of the intake end 23 is set as an intake port 24, a filter 25 is connected to the intake port 24, and the intake end 23 is provided therein with a one-way valve 231. The negative ion delivery device 3 includes a negative ion generator 31 which is communicated between the one-way valve 231 and the intake port 24 on the intake end 23; the negative ion generator 31 is connected with a power source 4 of a power machine, in order after electrically turning on, air between the intake port 24 on the intake end 23 and the one-way valve 231 will generate a large amount of negative ions by the action of the negative ion generator 31. When in practicing, the negative ion generator 31 used is preferably one produced by Song-Chiang Electronics Co., Ltd. in Taiwan, which is a negative ion generator numbered as STR-12 for generating large amount of negative ions without ozone and nitrogen oxide.

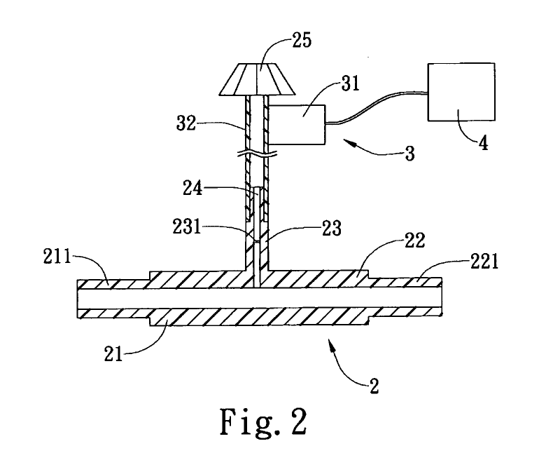

As shown in FIG. 2, in practicing, the above-mentioned negative ion delivery device 3 further includes a guide tube 32, two ends of the guide tube 32 are connected respectively with the intake port 24 on the intake end 23 of the communicating tube 2 and the filter 25, the negative ion generator 31 is connected with one side of the guide tube 32.

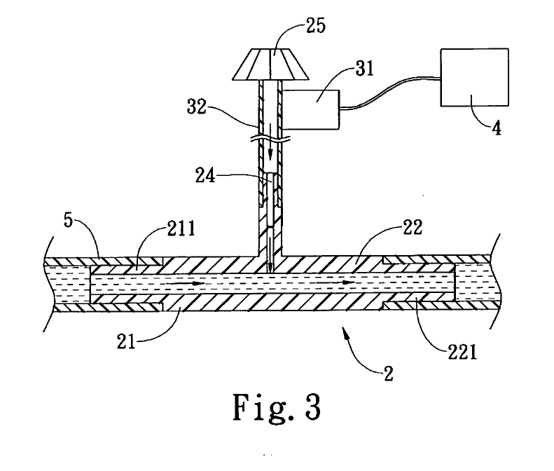

Referring to FIG. 3 showing the state of use of the present invention, wherein the internal combustion engine is for a power machine such as a car or a mower etc., an input tube 5 of the engine is cut into two sections which are connected respectively to connecting portions 211, 221 respectively of the input end 21 and the output end 22 of the communicating tube 2. When a driver exerts force on the accelerator of the power machine, the fuel in a fuel input tube 5 enters the input end 21 of the communicating tube 2 and is put out of the output end 22, because of fast flowing of the fuel, air in the intake port 24 and a large amount of negative ions generated by the negative ion generator 31 are brought through the guide tube 32 and then are put out in one way into the communicating tube 2 to form mixed gas by mixing with the fuel in the communicating tube 2. Further because the temperature of the fuel is lower than the room temperature, the air in the communicating tube 2 will be promptly lowered to reduce its volume and increase its density, the fuel thus can allow dissolving therein more air bringing a large amount of negative ions to become a kind of mixed gas with high oxygen dissolving amount. After the mixed gas enters the cylinder of the engine, except having an effect of high oxygen dissolving amount to increase the effects of combustion, the mixed gas can neutralize the positive ions generated by friction between the piston of the engine and the cylinder to thereby eliminate the resistance against piston running and thereby to increase the horsepower of the engine and to save fuel.

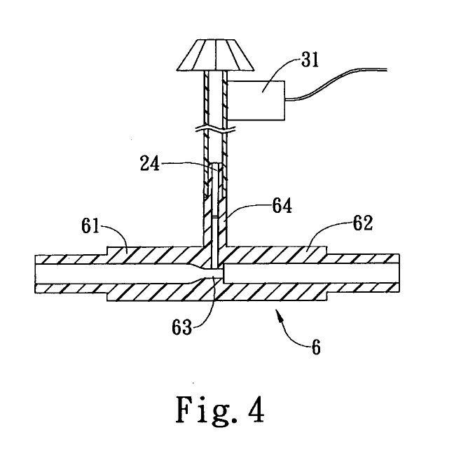

Referring to FIG. 4 showing a second embodiment of the fuel saving and waste gas purifying device 1 of the present invention, the difference of it from the first embodiment is resided in that: an input end 61 of an input tube 6 of the engine and an output end 62 have therebetween a reduced neck portion 63 which is communicated with an air intake end 64, the reduced neck portion 63 is communicated with the intake end 64. Thereby, when in flowing of the fuel in the fuel input tube 5, a negative pressure is generated to quickly absorb air in the intake port 24 and a large amount of negative ions generated by the negative ion generator 31.

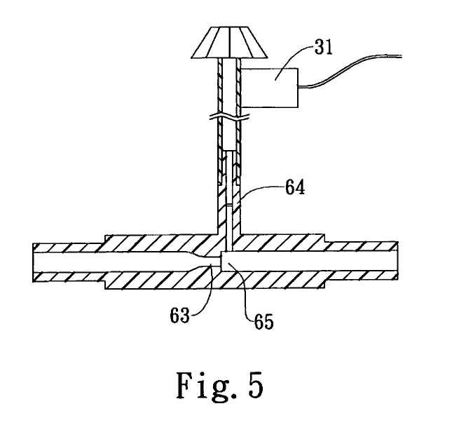

Referring to FIG. 5 showing a third embodiment of the fuel saving and waste gas purifying device 1 of the present invention, wherein a mixing chamber 65 is provided atone side of the reduced neck portion 63, the mixing chamber 65 is communicated with an intake end 64. When the fuel in the fuel input tube 5 passes the reduced neck portion 63 and reaches the mixing chamber 65, the fuel is in the state of spray to be sufficiently mixed with the air containing negative ions in the mixing chamber 65 in advance to form mixed gas. When the mixed gas enters the engine to mix once more with the intake gas of the engine per se (not shown), the fuel will mix with the air more completely, this can increase the efficiency of combustion.

Therefore, the present invention has the following advantages:
1. The present invention provides a second intake channel for an internal combustion engine, in order to compensate the loss resulted by the intake resistance made by an air filter and a throttle etc.; this can increase the oxygen dissolving amount of the fuel in the fuel input tube, thus combustion of the mixed gas can be more completely, and effects of combustion and output horsepower of the internal combustion engine can be increased.
2. The present invention can neutralize the positive ions generated by friction between the piston and the cylinder of the internal combustion engine to eliminate the phenomenon of positive ion static electricity absorption and to reduce the resistance against running of the piston and its linked members, thereby to save fuel.
3. The present invention can neutralize the contaminated floating dust (such as waste gas of a car, germs, virus etc.) having positive ions by discharging a large amount of negative ions out of a power machine, so that the dust is in a state of no electric charge and precipitates, and air can be effectively purified.
4. The present invention automatically absorbs air containing a large amount of negative ions by the action of negative pressure in order that the air is mixed with the fuel in the fuel input tube in advance; it is quite simple, convenient and practical.
5. The present invention cools the air entering the intake end of the communicating tube by using low temperature fuel, so that air temperature is lowered, air volume is reduced, and density is increased, these can increase the volume efficiency of the engine during gas taking in, so that an effect of completed combustion of the mixed gas can be obtained.
6. When in practical using, the present invention can have a plurality of negative ion generators mutually connecting in series, in order that the amount of negative ions generated can be multiplied to the amount of the positive ions generated by running of the engine; and the redundant negative ions are discharged together with the waste gas of the engine to effectively purify and improve the quality of the air.

In conclusion, according to the description disclosed above, the present invention surely can get the expected object thereof to provide a device of fuel saving of an internal combustion engine which not only can make completed combustion of mixed fuel to enhance combustion and output horsepower of the internal combustion engine, and can reduce the resistance against piston running in the internal combustion engine, but also can stabilize the waste gas in exhausting for air purification, Having thus described my invention with high practicable value, what I claim as new and desire to be secured by Letters Patent is:

1. A fuel saving and waste gas purifying device of an internal combustion engine, said device comprises:
a communicating tube including an input end, an output end and an intake end, said input end and said output end are connected respectively to a fuel input tube of an internal combustion engine in order that fuel in said fuel input tube enters said input end and is put out of said output end, said intake end is communicated with air outside of said communicating tube, said intake end is provided therein with a one-way valve; and
a negative ion delivery device including a negative ion generator which is communicated with said intake end of said communicating tube, a power source is connected with said negative ion generator, in order to generate a large amount of negative ions; by one-way putting out of said intake end of said communicating tube into said communicating tube, said negative ions are mixed with said fuel in said communicating tube.

2. The fuel saving and waste gas purifying device of an internal combustion engine as in claim 1, wherein: said negative ion delivery device further includes a guide tube and a filter connected to one end of said guide tube, other end of said guide tube is connected with said intake end of said communicating tube.

3. The fuel saving and waste gas purifying device of an internal combustion engine as in claim 1, wherein: said communicating tube includes a reduced neck portion which is located between said input end and said output end, and said reduced neck portion is communicated with said intake end.

4. The fuel saving and waste gas purifying device of an internal combustion engine as in claim 1, wherein: said communicating tube includes a reduced neck portion which includes a mixing chamber provided at one side of said reduced neck portion, and said mixing chamber is communicated with said intake end.
